(19) United States
(12) Patent Application Publication
(10) Pub. No.: US 2020/0118157 A1
(43) Pub. Date: Apr. 16, 2020

(54) SALES DATA PROCESSING APPARATUS

(71) Applicant: TOSHIBA TEC KABUSHIKI KAISHA, Tokyo (JP)

(72) Inventor: Ryuji Komori, Izu Shizuoka (JP)

(21) Appl. No.: 16/595,700

(22) Filed: Oct. 8, 2019

(30) Foreign Application Priority Data
Oct. 15, 2018 (JP) 2018-194259

(51) Int. Cl. G06Q 30/02

(52) U.S. Cl. CPC G06Q 30/0238

(57) ABSTRACT

A sales data processing apparatus comprises a display; a commodity specifying information acquisition determination section configured to determine whether commodity specifying information for specifying a commodity is acquired; a voucher extraction section configured to extract a voucher available to the commodity specified by the commodity specifying information acquired from vouchers stored in a memory section in association with the commodity specifying information, based on the commodity specifying information acquired; a display control section configured to control the display section to display the extracted voucher; and a settlement section configured to perform a settlement processing using one or a plurality of extracted vouchers on the commodity.

### CROSS-REFERENCE TO RELATED APPLICATION

This application is based upon and claims the benefit of priority from Japanese Patent Application No. 2018-194259, filed on Oct. 15, 2018, the entire contents of which are incorporated herein by reference.

### FIELD

Embodiments described herein relate generally to a sales data processing apparatus performing a sales registration processing and a settlement processing.

### BACKGROUND

In a retail store such as a supermarket, a convenience store, and a shopping center sales promotion tickets or vouchers such as a gift certificate for discount or reduction of an amount of a specific commodity, and an exchange coupon for exchange with a specific commodity are distributed to enhance the motivation of customer to visit the store or to promote sales of commodities. The customer who comes to the store can use these vouchers to purchase a specific commodity at a lower price or can exchange the voucher for a specific commodity.

Incidentally, commodities to which these vouchers are available are specified in advance. Therefore, in the retail store, a store clerk who performs a commodity sales registration by a POS (Point of Sales) terminal serving as a sales data processing apparatus needs to memorize such commodities to which the vouchers are available for each voucher or to confirm the voucher every time the customer uses the voucher. As a result, a burden on the store clerk is increased, and thus the store clerk may erroneously accept an incorrect voucher from the customer.

### DESCRIPTION OF THE DRAWINGS

FIG. 1 is a block diagram illustrating a hardware structure of a POS terminal according to an embodiment;

FIG. 2 is a diagram illustrating a commodity master file;

FIG. 3 is a diagram illustrating a voucher memory area;

FIG. 4 is a functional block diagram illustrating functional components of the POS terminal;

FIG. 5 is a flowchart depicting a flow of a control processing performed by the POS terminal;

FIG. 6 is a diagram illustrating a display screen on the POS terminal;

FIG. 7 is a diagram illustrating another display screen on the POS terminal;

FIG. 8 is a diagram illustrating still another display screen on the POS terminal;

FIG. 9 is a diagram illustrating still another display screen on the POS terminal; and

FIG. 10 is a diagram illustrating still another display screen on the POS terminal.

### DETAILED DESCRIPTION

In accordance with an embodiment, a sales data processing apparatus comprises a display section configured to display information thereon; a commodity specifying information acquisition determination section configured to determine whether commodity specifying information for specifying a commodity is acquired; a declaration section configured to declare use of a voucher; a voucher extraction section configured to extract a voucher available to the commodity specified by the commodity specifying information determined to be acquired by the commodity specifying information acquisition determination section from vouchers stored in a memory section in association with the commodity specifying information, based on the commodity specifying information determined to be acquired by the commodity specifying information acquisition determination section when the use of the voucher is declared; a display control section configured to control the display section to display the extracted voucher; and a settlement section configured to perform a settlement processing using one or a plurality of extracted vouchers on the commodity.

Embodiments are described in detail with reference to the accompanying drawings. In the embodiments described below, a POS terminal is described as an example of a sales data processing apparatus.

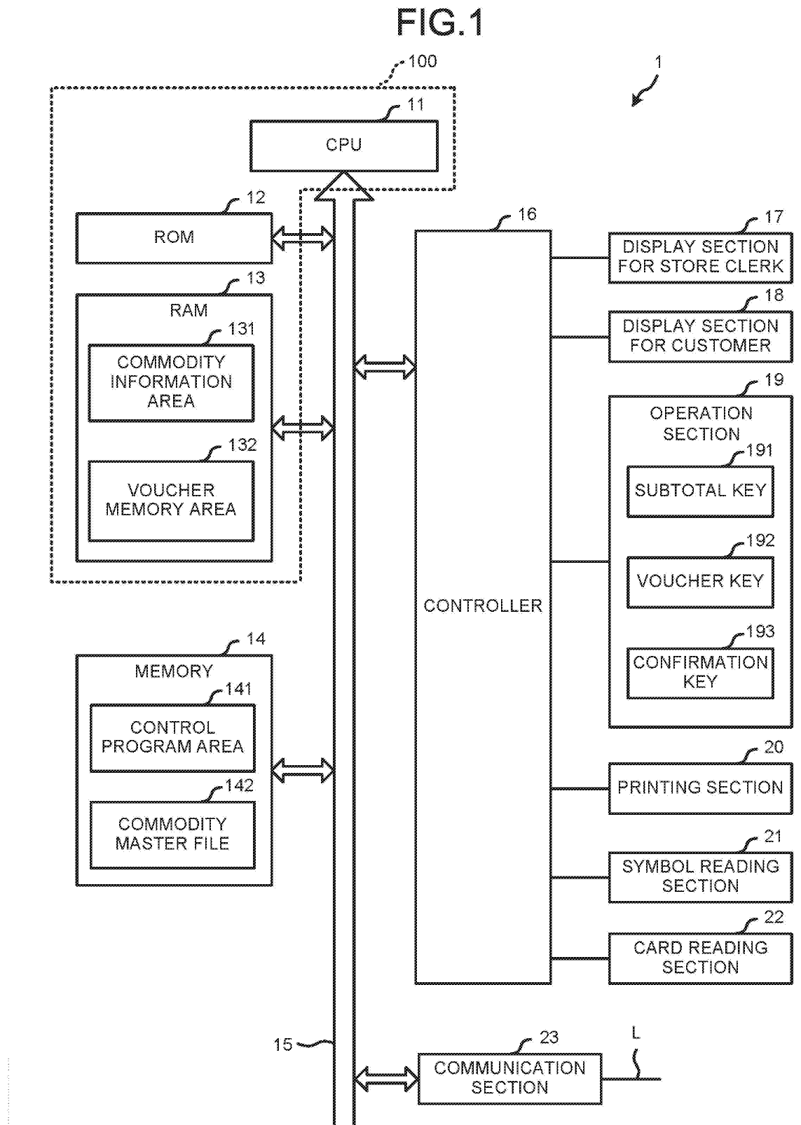

FIG. 1 is a block diagram illustrating a hardware structure of the POS terminal according to the present embodiment. The POS terminal 1 executes a sales registration processing and a settlement processing on a commodity sold in the retail store. The sales registration processing refers to a processing of capturing an image of a code symbol such as a barcode attached to a commodity to be sold or optically scanning the code symbol to obtain a commodity code, displaying commodity information (i.e., a commodity name, a price, and the like) of the commodity read out from a commodity master file based on the acquired commodity code, and storing the commodity information in a commodity information area 131 of a RAM (Random Access Memory) 13. The settlement processing refers to a processing of displaying a total amount relating to the transaction based on the commodity information stored in the RAM in the sales registration processing, and calculating and displaying a change amount based on an amount deposited from a customer. The POS terminal 1 issues a receipt on which the commodity information, settlement information and the like (such as, day and time of sales and the name of a person in charge (cashier)) are printed. The POS terminal 1 transmits the commodity information and the settlement information as sales data via a communication line L to a host server (not shown) such as a store server.

As shown in FIG. 1, the POS terminal 1 includes a CPU (Central Processing Unit) 11, a ROM (Read Only Memory) 12, the RAM 13 and a memory 14. The CPU 11 serves as a main body for control. The ROM 12 stores various programs. Programs and various kinds of data are copied or decompressed on the RAM 13. The memory 14 also stores various programs. The CPU 11, the ROM 12, the RAM 13 and the memory 14 are connected to one another via a bus line 15. The CPU 11, the ROM 12 and the RAM 13 constitute a control section 100. Specifically, the CPU 11 operates according to a control program stored in the ROM 12 or the memory 14 and copied or decompressed on the RAM 13, and in this way, the control section 100 executes a processing of controlling the POS terminal 1 described below.

The RAM 13 includes the commodity information area 131 and a voucher memory area 132. The commodity information area 131 stores the commodity information (i.e., a commodity name, a commodity price, etc.) of the commodity on which the sales registration processing is performed based on a commodity code acquired by analyzing a code symbol scanned by a symbol reading section 21. The voucher memory area 132 is described below with reference to FIG. 3.

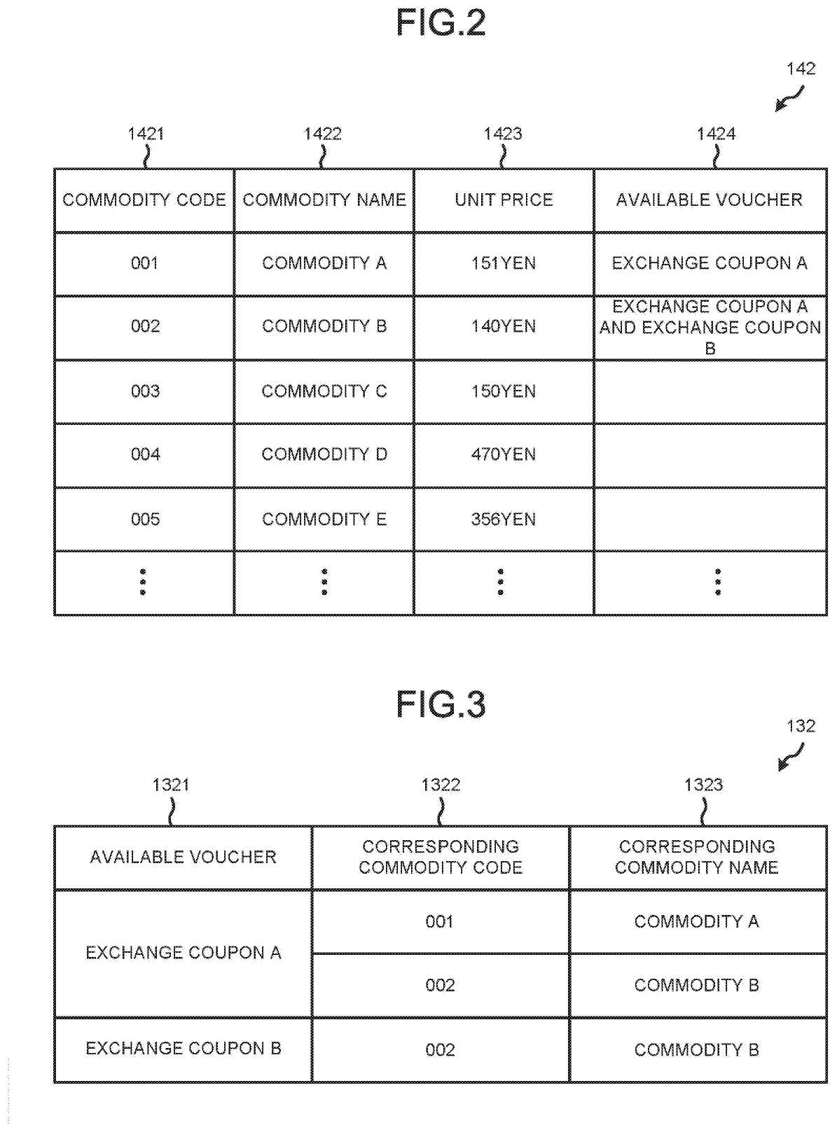

The memory 14 is a non-volatile memory such as an HDD (Hard Disk Drive) or a flash memory that holds stored information even when a power supply thereto is turned off. The memory 14 includes a control program area 141 and a commodity master file 142. The control program area 141 stores a control program for controlling the POS terminal 1. The commodity master file 142 stores the commodity information (i.e., a commodity code, a commodity name, a unit price (amount), etc.) of the commodity by the commodity code for specifying the commodity sold in the retail store. The commodity master file 142 is described below with reference to FIG. 2.

The control section 100 is connected to a display section for store clerk 17, a display section for customer 18, an operation section 19, a printing section 20, a symbol reading section 21 and a card reading section 22 via the bus line 15 and a controller 16. The display section for store clerk 17 displays information such as commodity information and settlement information to a store clerk who operates the POS terminal 1. The display section for customer 18 displays information such as the commodity information and the settlement information to a customer. The operation section 19 is a keyboard such as a numeric keypad and a department key (category key). The operation section 19 includes a subtotal key 191 serving as a settlement key, a voucher key 192 serving as a declaration section, and a confirmation key 193. The subtotal key 191 is operated when the sales registration processing in one transaction is terminated and the settlement processing is started. The voucher key 192 is operated when a voucher is used. The confirmation key 193 is operated to confirm designation of a commodity to which the voucher is used among commodities to which the voucher is available.

The printing section 20 has, for example, a well-known thermal transfer type thermal head (not shown) to issue a receipt (elongated sheet) created by printing the commodity information and the settlement information of the purchased commodity on a rolled sheet by the thermal head. The symbol reading section 21 optically scans a code symbol such as a barcode or a two-dimensional code attached to the commodity. Alternatively, the symbol reading section 21 captures an image of the code symbol attached to the commodity. The POS terminal 1 analyzes the read code symbol or the captured image of the code symbol to acquire a commodity code for specifying the commodity to which the code symbol is attached. The card reading section 22 magnetically or electrically acquires a card number, i.e., a customer specifying information, from a card type medium (e.g., a credit card, electronic money card, etc.) which is used at the time of purchasing the commodity (settlement processing).

The control section 100 is connected to a communication section 23 via the bus line 15. The communication section 23 is connected to the host server via the communication line L.

Next, the commodity master file 142 is described. The commodity master file 142 stores various kinds of information of the commodity specified by the commodity code in association with the commodity code (commodity specifying information) for specifying the commodity. FIG. 2 is a diagram illustrating the commodity master file 142. As shown in FIG. 2, the commodity master file 142 has a commodity code column 1421, a commodity name column 1422, a unit price column 1423 and an available voucher column 1424.

The commodity code column 1421 stores a commodity code. The commodity code is indicated by a numeral and/or an alphabet to specify a commodity. The commodity name column 1422 stores a commodity name of the commodity specified by the commodity code. The unit price column 1423 stores a unit price of the commodity specified by the commodity code. The available voucher column 1424 stores a voucher available to the commodity specified by the commodity code. In FIG. 2, an exchange coupon A as the voucher is stored in association with a commodity A specified by a commodity code “001”. Specifically, the voucher A, i.e., exchange coupon A, is available to the commodity A. The exchange coupon A and an exchange coupon B as vouchers are stored in association with a commodity B specified by a commodity code “002”. Specifically, the voucher A, i.e., exchange coupon A, and a voucher B, i.e., exchange coupon B, are available to the commodity B. Hereinafter, the exchange coupon A is described as the voucher A, and the exchange coupon B is described as the voucher B.

In FIG. 2, no available voucher is stored in the available voucher columns 1424 respectively corresponding to a commodity C specified by a commodity code “003”, a commodity D specified by a commodity code “004”, and a commodity E specified by a commodity code “005”. This indicates that no voucher is available to the commodity C, the commodity D and the commodity E. In other words, the voucher cannot be used for the commodity C, the commodity D and the commodity E.

The commodity master file 142 stores an available voucher in the available voucher column 1424 for a commodity to which the voucher is available among commodities sold in the retail store. The commodity master file 142 does not store the available voucher in the available voucher column 1424 for a commodity to which the voucher is not available. For the commodity to which the voucher is not available, information indicating that no voucher is available may be stored in the available voucher column 1424.

In the following, the description is made on assumption that the sales registration processing is performed on the commodity A, the commodity B, the commodity C, the commodity D and the commodity E.

The voucher memory area 132 is described. The voucher memory area 132 stores the voucher available to the commodity to which the sales registration processing is performed. The detailed description of the voucher memory area 132 is made below. The voucher memory area 132 extracts a voucher from the available voucher column 1424 if the voucher available to the commodity to which the sales registration processing is performed is stored in the available voucher column 1424 to store the extracted voucher therein.

FIG. 3 is a diagram illustrating the voucher memory area 132. As shown in FIG. 3, the voucher memory area 132 includes an available voucher column 1321, a corresponding commodity code column 1322 and a corresponding commodity name column 1323. The available voucher column 1321 stores voucher specifying information, e.g., a voucher code, a voucher name, etc., for specifying a voucher available to the commodity to which the sales registration processing is performed. The corresponding commodity code column 1322 stores a commodity code of the commodity to which the specified voucher is available. The corresponding commodity name column 1323 stores a commodity name of the commodity to which the specified voucher is available.

In FIG. 3, for the commodity A and the commodity B on which the sales registration processing is performed, by referring to the available voucher column 1424, the voucher A and the voucher B are extracted and respectively stored in the available voucher columns 1321 of the voucher memory area 132 as the available vouchers. The commodity A and the commodity B are stored in the corresponding commodity name column 1323 in association with the voucher A as the commodities to which the voucher A is available. The commodity B is stored in the corresponding commodity name column 1323 in association with the voucher B as the commodity to which the voucher B is available.

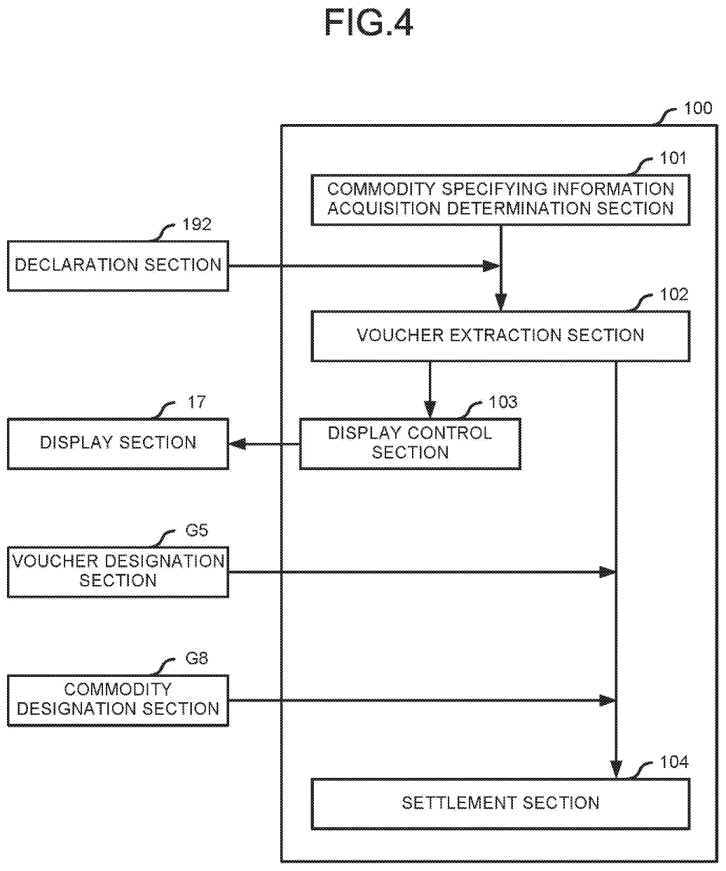

The functional components of the POS terminal 1 are described below. FIG. 4 is a functional block diagram illustrating functional components of the POS terminal 1. As shown in FIG. 4, the control section 100 of the POS terminal 1 functions as a commodity specifying information acquisition determination section 101, a voucher extraction section 102, a display control section 103 and a settlement section 104.

The commodity specifying information acquisition determination section 101 determines whether the commodity specifying information for specifying the commodity is acquired. The commodity specifying information acquisition determination section 101 determines whether the commodity code of the commodity is acquired based on the code symbol, read (scanned or photographed) by the symbol reading section 21, which is attached to the commodity.

The voucher extraction section 102 extracts a voucher available to the commodity specified by the commodity code determined as being acquired by the commodity specifying information acquisition determination section 101 from vouchers available to the commodities stored in the commodity master file 142 respectively in association with the commodity codes when the voucher key 192 serving as the declaration section is operated to declare use of the voucher. The voucher extraction section 102 may extract the voucher available from the commodity master file 142 when the voucher key 192 serving as the declaration section is operated. The voucher extraction section 102 may extract the available voucher from, for example, the commodity information area 131 among the vouchers read out from the commodity master file 142 and stored in the commodity information area 131 in advance when the voucher key 192 is operated. In the present embodiment, the available voucher is extracted from the commodity information area 131.

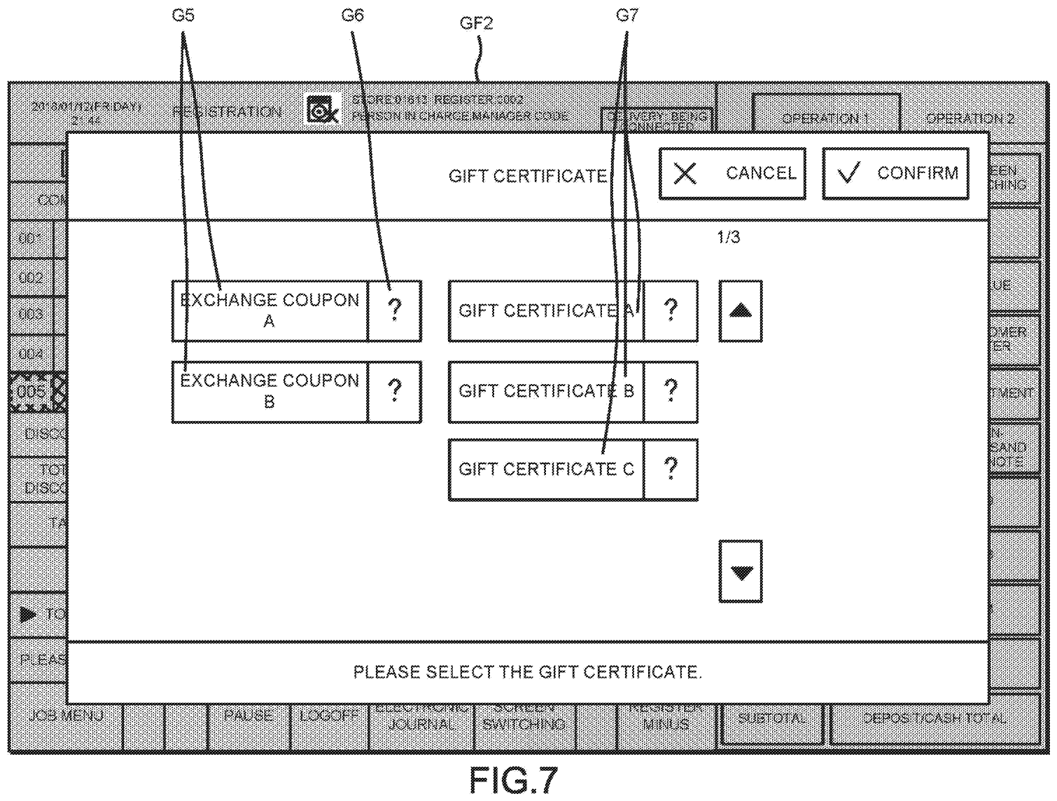

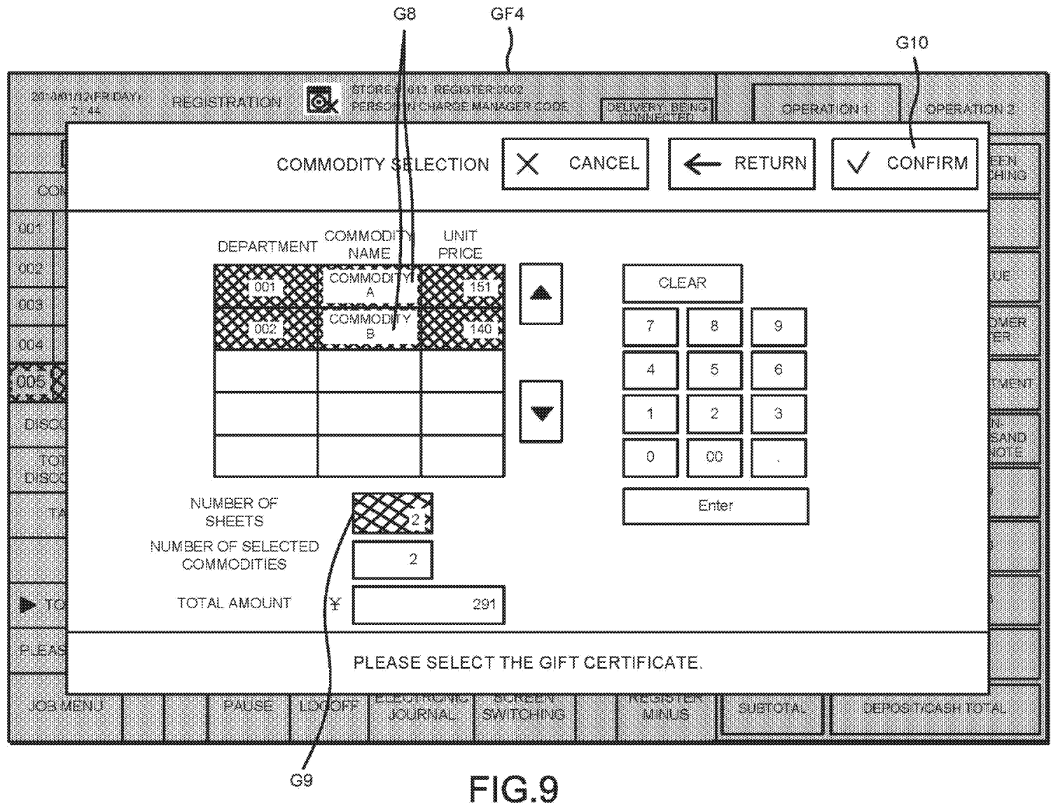

The display control section 103 controls the display section for store clerk 17 to display the voucher extracted by the voucher extraction section 102. The display control section 103 further controls the display section for store clerk 17 to display the commodity to which the voucher designated by an operation on a key G5 (refer to FIG. 7), i.e., voucher designation section, is available on the display section for store clerk 17. The display control section 103 still further controls the display section for store clerk 17 to display the number of vouchers required according to the number of commodities designated by a key G8 (refer to FIG. 9), i.e., commodity designation section, on the display section for store clerk 17.

The settlement section 104 performs the settlement processing on the commodity with the extracted voucher. The settlement section 104 performs the settlement processing with the voucher designated by the key G5 from the vouchers displayed on the display section for store clerk 17. The settlement section 104 performs the settlement processing for a discount, an exchange or a reduction on the commodity to which the voucher designated by the key G5 from the vouchers displayed on the display section for store clerk 17 is available. The settlement section 104 performs the settlement processing on the commodity designated by the key G8 with the voucher designated by the key G5.

The control performed by the POS terminal 1 is described below. A case in which the exchange coupon is used as the voucher is described. Therefore, the voucher in the following description serves as the exchange coupon. The exchange coupon is used to get a specific commodity (e.g., a commodity indicated on the exchange coupon) free of charge. Therefore, the exchange processing of the exchange coupon for the commodity is equivalent to a discount processing in which the amount of the commodity is reduced by the unit price of the commodity.

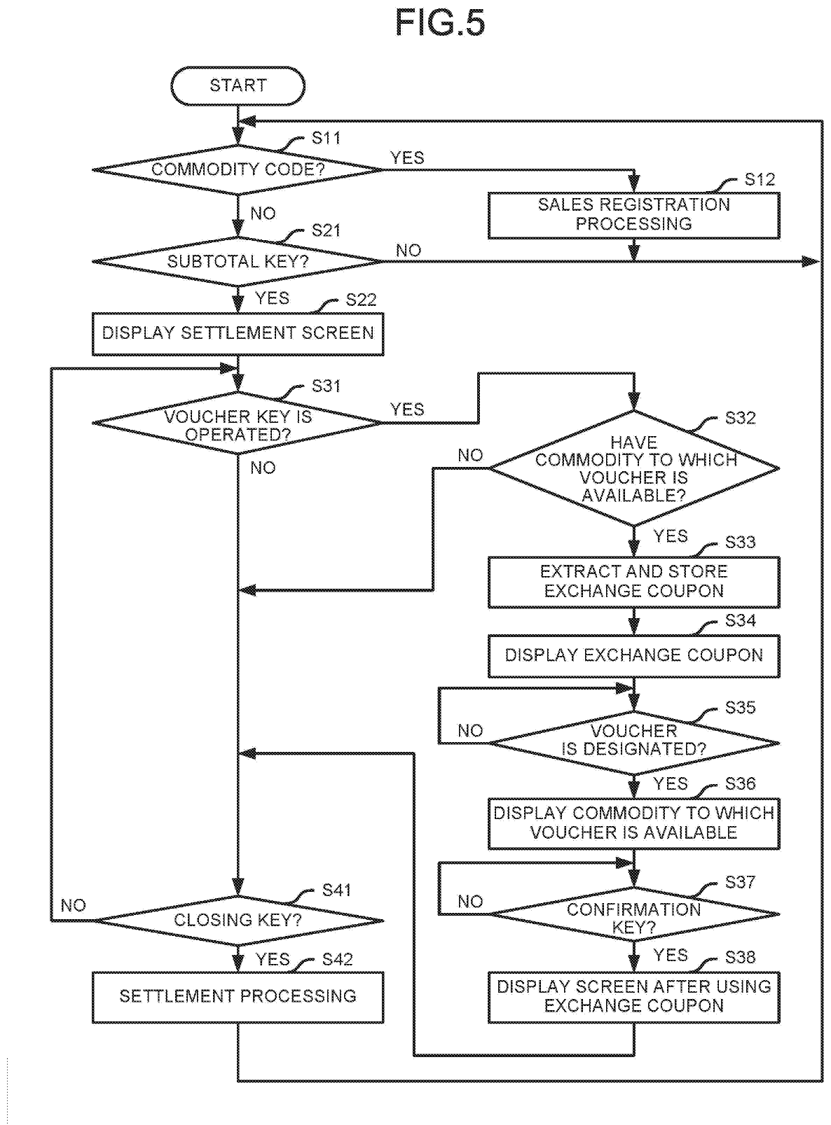

FIG. 5 is a flowchart depicting a flow of a control processing performed by the POS terminal. As shown in FIG. 5, the commodity specifying information acquisition determination section 101 of the POS terminal 1 determines whether the commodity code is acquired (Act S11). If the commodity specifying information acquisition determination section 101 determines that the commodity code is acquired (Yes in Act S11), the control section 100 executes the sales registration processing on the commodity specified by the acquired commodity code (Act S12). In the processing in Act S12, if the available voucher is stored in the available voucher column 1424 in association with the acquired commodity code, the control section 100 stores the information relating to the voucher specified by the commodity code in the commodity information area 131. Then, the control section 100 returns to the processing in Act S11.

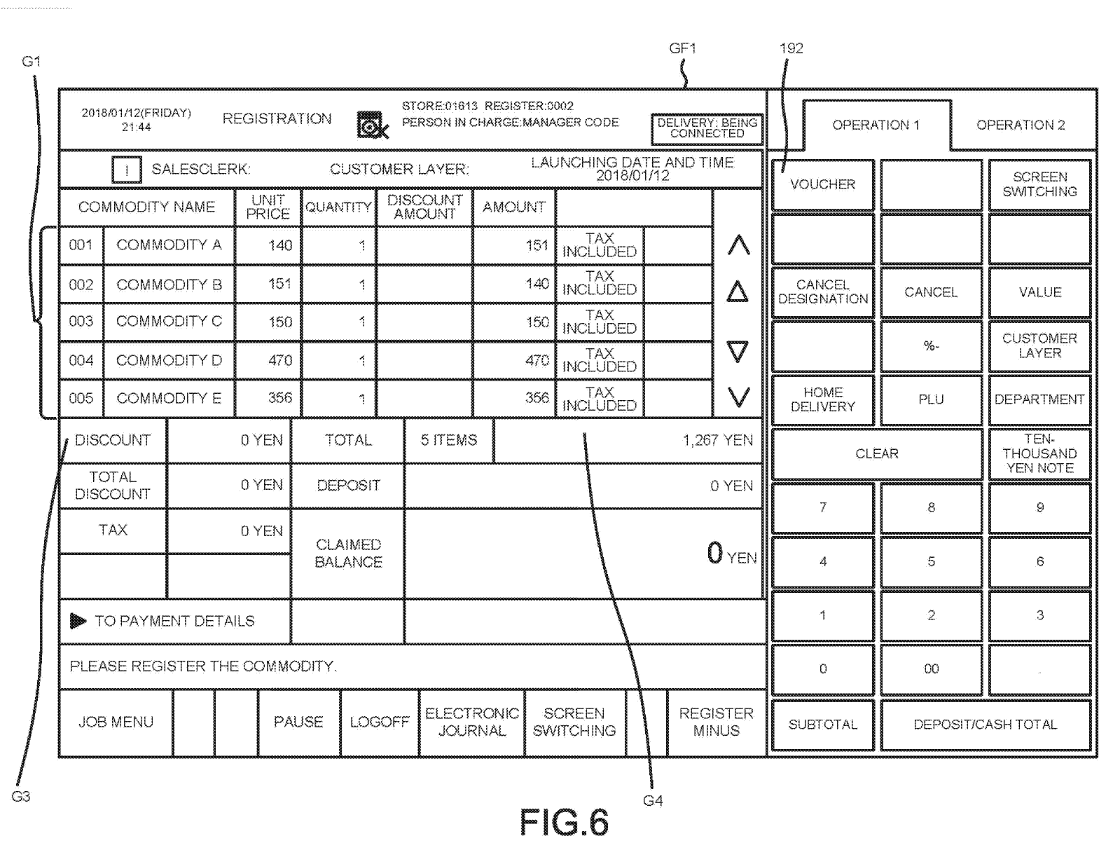

In Act S11, if the commodity specifying information acquisition determination section 101 determines that the commodity code is not acquired (No in Act S11), the control section 100 determines whether the subtotal key 191 (refer to FIG. 6) serving as a closing key is operated (Act S21). If it is determined that the subtotal key 191 is not operated (No in Act S21), the control section 100 returns to the processing in Act S11. On the other hand, if it is determined that the subtotal key 191 is operated (Yes in Act S21), the control section 100 controls the display section for store clerk 17 to display the commodity information of all the commodities to which the sales registration processing is performed (Act S22).

FIG. 6 is a diagram illustrating a screen GF1 displayed in Act S22. On the screen GF1, an area G1 for displaying the commodity information of the commodity to which the sales registration processing is performed, an area G2 for displaying a discount amount, an area G3 for displaying a used voucher, and an area G4 for displaying total quantity and a total amount of commodities to which the sales registration processing is performed are displayed. In the area G1, a commodity code, a commodity name, an amount, a type of tax, and the like are displayed as the commodity information of the commodity. The screen GF1 also displays the voucher key 192. The voucher key 192 is operated to declare use of the voucher. In this state, since the voucher is not used yet, nothing is displayed in the area G3.

Returning again to the description of FIG. 5. Next, the control section 100 determines whether the voucher key 192 is operated (Act S31). If it is determined that the voucher key 192 is operated (Yes in Act S31), the control section 100 determines whether there is a commodity to which the voucher is available according to the commodity information of the commodities, on which the sales registration processing is being performed, stored in the commodity information area 131 (Act S32). If the information relating to the available voucher is stored in association with the commodity information stored in the commodity information area 131, the control section 100 determines that there is a commodity to which the voucher is available. However, if no information relating to the available voucher is stored in association with any of the commodity information stored in the information area 131, the control section 100 determines that there is no commodity to which the voucher is available.

If an information retrieval is made in the commodity master file 142 by the commodity code, acting as a retrieval key, contained in the commodity information stored in the commodity information area 131 and information of the available voucher relating to the commodity code is stored in the corresponding available voucher column 1424, the control section 100 determines that there is a commodity to which the voucher is available. On the other hand, if no information relating to the available voucher is stored in any of the corresponding available voucher column 1424, the control section 100 determines that there is no commodity to which the voucher is available.

If it is determined that there is a commodity to which the voucher is available according to the commodity information stored in the commodity information area 131 (Yes in Act S32), the voucher extraction section 102 extracts the available voucher and the commodity information (e.g., a commodity code, and a commodity name) of the commodity to which the voucher is available and stores them in the voucher memory area 132 (Act S33). Specifically, the voucher available to the commodity to which the sales registration processing is performed and the commodity information of the commodity to which the voucher is available are stored in the voucher memory area 132. Then, the display control section 103 controls the display section for store clerk 17 to display the voucher extracted by the voucher extraction section 102 (Act S34).

FIG. 7 is a diagram illustrating a screen GF2 for displaying the voucher displayed in Act S34. On the screen GF2, a key G5 (two keys G5 in FIG. 7) on which an available voucher name (an exchange coupon A and an exchange coupon B on the keys G5 in FIG. 7) is shown and a key G6 (two keys G6 in FIG. 7) on which a question mark “?” is shown are correspondingly displayed. The displayed keys G5 and G6 can be operated. When the key G5 is operated, the voucher associated with the operated key G5 is designated. In FIG. 7, when the key G5 on which the exchange coupon A is shown is operated, the exchange coupon A is designated. When the key G5 on which the exchange coupon B is shown is operated, the exchange coupon B is designated. The key G5 acts as a voucher designation section. When the key G6 on which a question mark “?” is shown is operated, detailed information of the corresponding voucher (for example, the image of the voucher, i.e., exchange coupon A or B) is displayed in a pop-up manner. For example, if the key G6 corresponding to the key G5 on which exchange coupon A is shown is operated, the image of the exchange coupon A is displayed.

In FIG. 7, apart from the voucher, a key G7 on which the name of a cash voucher such as a gift certificate available to the transaction with the customer at this time is shown is displayed on the screen GF2. The displayed key G7 can be operated. For example, when the key G7 on which a gift certificate A is shown is operated, the discount processing in which an amount indicated on the gift certificate A is reduced or subtracted from the total amount of the transaction can be performed.

Returning again to the description in FIG. 5. Next, the control section 100 determines whether one of the vouchers is designated by an operation on one of the keys G5 acting as the voucher designation section (Act S35). The control section 100 stands by until one of the vouchers is designated (No in Act S35), and if it is determined that one of the vouchers is designated by one of the keys G5 (Yes in Act S35), the display control section 103 controls the display section for store clerk 17 to display the commodity to which the voucher designated by the operation on the key G5 is available (Act S36). For example, if one of the keys G5 on which the exchange coupon A is shown is operated, a commodity to which the exchange coupon A is available is displayed.

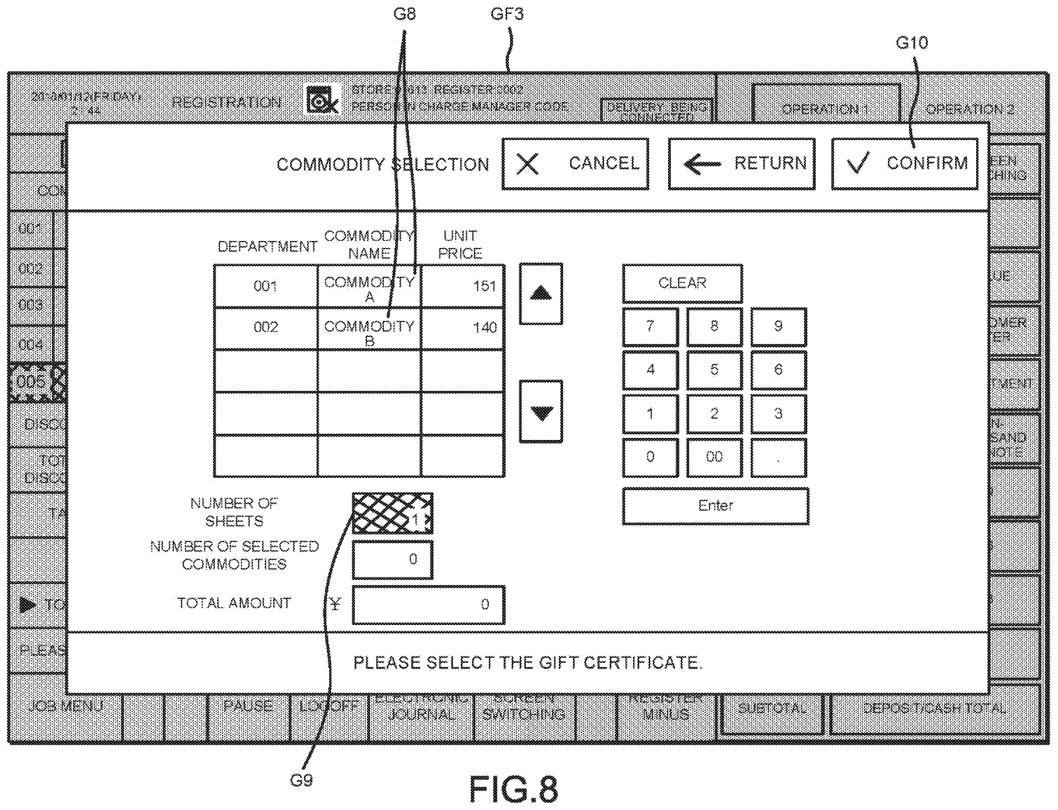

FIG. 8 is a diagram illustrating a screen GF3 on which the commodity to which the voucher displayed in Act S36 is available is displayed. In FIG. 8, the commodity to which the voucher is available is displayed when the key G5 on which the voucher, i.e., the exchange coupon A, is shown is operated. As shown in FIG. 8, the screen GF3 displays a key G8 on which a commodity to which the voucher associated with the operated key G5 is available is shown, an area G9 for displaying the number of vouchers to be used, and a confirmation key G10 for confirming the type of the voucher and the commodity to which the voucher is applied. The key G8 and the confirmation key G10 can be operated.

The store clerk who operates the POS terminal 1 asks the customer about a commodity to which the voucher is applied and designates the commodity on the screen GF3. The commodity to which the voucher is applied is designated by operating the key G8. The key G8 acts as a commodity designation section. FIG. 9 shows a screen GF4 in the state in which a commodity is designated by operating the key G8. In FIG. 9, the key G8 on which the commodity A is shown and the other key G8 on which the commodity B are operated, and in this way, the commodity A and the commodity B are designated. The store clerk operates the confirmation key G10 after designating the commodities A and B to which the vouchers are respectively applied.

In the processing in Act S36, the display control section 103 displays the number of the required vouchers in accordance with the number of commodities designated by operating the key G5 on the screen GF4. In FIG. 9, the two commodities including the commodity A and the commodity B are designated as the commodities to which the vouchers are applied, and thus the display control section 103 controls the display section for store clerk 17 to display “2” as the number of required vouchers in the area G9 on the screen GF4.

Returning again to the description in FIG. 5. Next, the control section 100 determines whether the confirmation key G10 is operated (Act S37). The control section 100 stands by until the confirmation key G10 is operated (No in Act S37), and if it is determined that the confirmation key G10 is operated (Yes in Act S37), the control section 100 displays a screen GF5 on which the use of the voucher is reflected on the display section for store clerk 17 (Act S38).

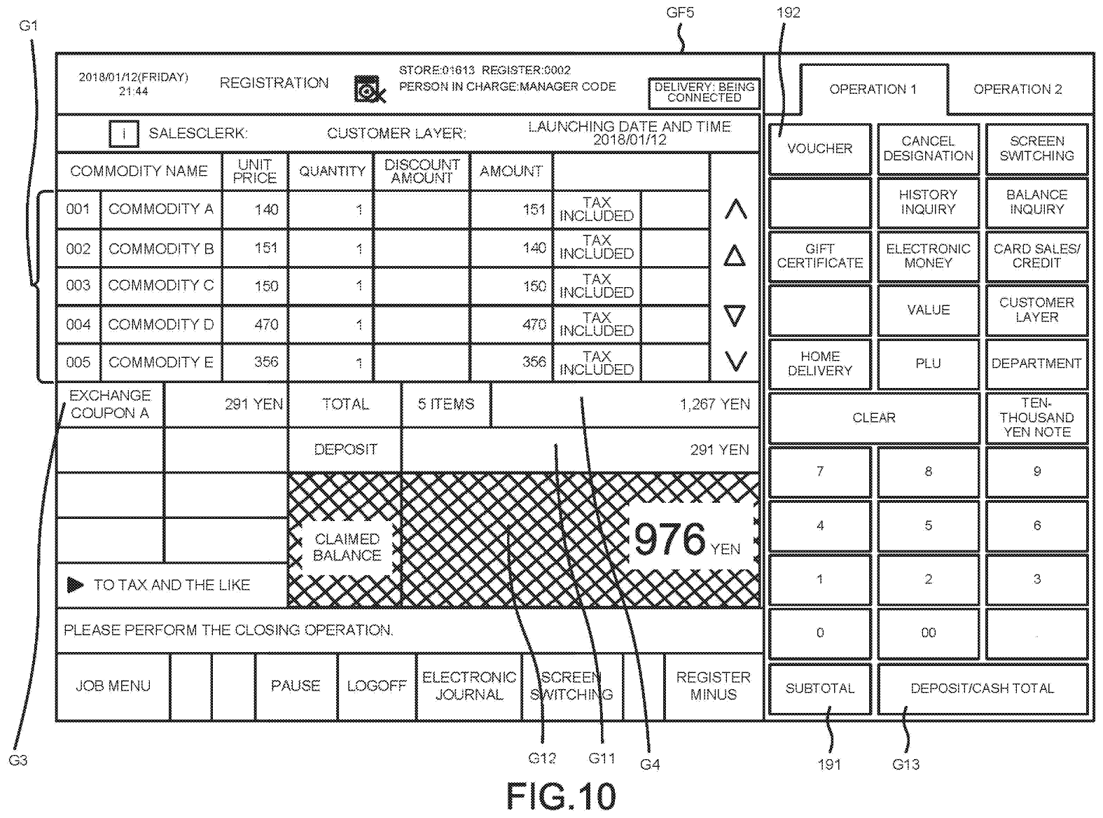

FIG. 10 is a diagram illustrating the screen GFS displayed in Act S38. The number of used vouchers (exchange coupon A) is displayed in the area G3 on the screen GF5. In FIG. 10, the voucher (exchange coupon A) is used for the commodities A and B, and thus “2” is displayed as the number of the used vouchers in the area G3. The screen GF5 displays an area G11 for displaying a discount equivalent amount substantially reduced by using the voucher or vouchers, and an area G12 for displaying a billing amount calculated by subtracting the discount equivalent amount from the total amount. In FIG. 10, the total amount of the commodity A and the commodity B is discounted as a result of use of the vouchers applied to the commodity A and the commodity B, and thus a total amount (291 Yen) of an amount (price) of the commodity A, i.e., 151 yen, and an amount (price) of the commodity B, i.e., 140 yen, is displayed as the discount equivalent amount in the area G11. In the area G12, an amount (976 Yen) obtained by reducing the discount equivalent amount (291 Yen) from the total amount (1267 Yen) displayed in the area G4 is displayed. Further, a cash total key G13 acting as a settlement key for terminating the transaction is displayed on the screen GF5.

Returning again to the description in FIG. 5. Next, the control section 100 determines whether the cash total key G13 is operated (Act S41). If it is determined that the cash total key G13 is operated, the settlement section 104 performs the settlement processing on the commodity, using the extracted voucher. Specifically, among the vouchers displayed under the control of the display control section 103, the settlement section 104 uses the voucher designated by the operation on the key G5 to perform the settlement processing by applying the extracted voucher to the commodity designated by the operation on the key G8 (Act S42). Then, the control section 100 returns to the processing in Act S11. If it is determined that the cash total key G13 is not operated (No in Act S41), the control section 100 returns to the processing in Act S31.

In the present embodiment, in the processing in Act S42, through reception of two vouchers A, values of which are equivalent to deposition of cash (291 Yen) corresponding to total amount of the commodity A and the commodity B, designated by the operation on the key G5 from the customer, the settlement processing is performed on the commodity A and the commodity B with the two vouchers corresponding to the deposited amount. Specifically, two vouchers A are accepted and the settlement processing of exchange for the commodity A and the commodity B is performed. Such settlement processing is equivalent to the discounting processing of reducing a settlement amount by 291 Yen, i.e., the total amount of the commodity A and the commodity B.

In the settlement processing in Act S42, the control section 100 generates transaction data including the commodity information and the settlement information of the commodity on which the settlement processing is performed. The transaction data is transmitted to the host server at an appropriate timing (for example, at the end of today's business or closing of the retail store). Then, the control section 100 generates, as a part of the transaction data, the type of the used voucher and the commodity to which the voucher is applied in an associated manner. By doing this, number of commodities and number of vouchers are respectively totaled such that each commodity is associated with each voucher applied to the commodity one by one to be able to manage the type of the used voucher and the commodity to which the voucher is applied. Thus, sales of commodity can be promoted as well by analyzing the type of the voucher that is most frequently used.

If it is determined in Act S31 that the voucher key 192 is not operated (No in Act S31), but the cash total key G13 is operated (Yes in Act S41), the control section 100 performs the settlement processing in which no voucher is used. Further, if it is determined in Act S32 that the commodity information stored in the commodity information area 131 includes no commodity to which the voucher is available (No in Act S32), the control section 100 performs the settlement processing without the voucher.

According to such an embodiment described above, the POS terminal 1 extracts the voucher available to the commodity to which the sales registration processing is performed to display the extracted voucher, and performs the settlement processing on the commodity using the extracted voucher. Therefore, the burden on the store clerk is not increased even when the customer uses the voucher.

According to the present embodiment, the number of the vouchers to be required is displayed by designating the commodity to which the voucher is applied. Therefore, the store clerk can easily grasp the number of the vouchers to be used.

According to the present embodiment, the transaction data including the used voucher and the corresponding commodity to which the voucher is applied is generated. Therefore, it can manage the used voucher and the commodity to which the voucher is applied by totalizing the number of the used vouchers and the number of the commodities.

In the present embodiment, the POS terminal 1 is provided with the commodity master file 142. However, it is not limited thereto. For example, the commodity master file maybe provided in another device (for example, the host server of the POS terminal 1) connected to the POS terminal 1.

In the present embodiment, two vouchers are used. However, the number of vouchers used at a time is not limited thereto, and one or a plurality of vouchers may be used.

The program executed by the POS terminal 1 of the embodiment is recorded in a computer-readable recording medium such as a CD-ROM (compact disc read-only memory), an FD (Flexible Disk), a CD-R (Compact Disk Recordable), a DVD (Digital Versatile Disk) and the like in the form of installable or executable file to be provided.

The program executed by the POS terminal 1 of the embodiment may be provided by being stored in a computer connected with a network such as the Internet and downloaded via the network. The program executed by the POS terminal 1 of the embodiment may be provided or distributed via the network such as the Internet.

The program executed by the POS terminal 1 of the embodiment may be provided by being incorporated in a ROM or the like in advance.

As described above, while certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A sales data processing apparatus, comprising:
a display configured to display information;
a commodity specifying information acquisition determination section configured to determine whether commodity specifying information for specifying a commodity is acquired;
a voucher extraction section configured to extract a voucher available to the commodity specified by the commodity specifying information acquired by the commodity specifying information acquisition determination section from vouchers stored in a memory in association with the commodity specifying information, based on the commodity specifying information acquired by the commodity specifying information acquisition determination section;
a display control section configured to control the display to display an extracted voucher; and
a settlement section configured to perform a settlement processing using one or a plurality of extracted vouchers on the commodity.

2. The sales data processing apparatus according to claim 1, further comprising a voucher designation section configured to designate a voucher displayed on the display, wherein the settlement section performs settlement processing using the voucher designated by the voucher designation section from the vouchers displayed on the display.

3. The sales data processing apparatus according to claim 2, wherein the settlement section performs settlement processing including a discount processing, an exchange processing, or a reduction processing on a commodity to which the voucher designated by the voucher designation section is available among vouchers displayed on the display.

4. The sales data processing apparatus according to claim 3, further comprising a commodity designation section configured to designate a commodity to which the voucher is applied on the display, wherein
the display control section controls the display to display commodities to which the voucher designated by the voucher designation section is available, and
the settlement section performs settlement processing using the voucher associated with the commodity specifying information of the commodity designated by the commodity designation section among commodities displayed on the display.

5. The sales data processing apparatus according to claim 4, wherein the display control section controls the display to display a number of required vouchers in accordance with a number of commodities designated by the commodity designation section.

6. The sales data processing apparatus according to claim 1, further including a declaration section configured to declare use of the voucher, wherein
the voucher extraction section is further configured to extract the voucher available to the commodity specified by the commodity specifying information acquired by the commodity specifying information acquisition determination section from vouchers stored in the memory section in association with the commodity specifying information, based on the commodity specifying information acquired by the commodity specifying information acquisition determination section when the use of the voucher is declared.

7. The sales data processing apparatus according to claim 1, wherein the commodity specifying information acquisition determination section determines whether commodity specifying information for specifying the commodity is acquired by scanning a barcode associated with the commodity.

8. The sales data processing apparatus according to claim 1, wherein the commodity specifying information comprises at least one of a commodity code, a commodity name, and a unit price of the commodity.

9. A method for performing a settlement processing using a voucher by a sales data processing apparatus, comprising:
determining whether commodity specifying information for specifying a commodity is acquired;
declaring use of the voucher;
extracting a voucher available to the commodity specified by the commodity specifying information acquired from vouchers in association with the commodity specifying information, based on the commodity specifying information acquired when the use of the voucher is declared;
displaying the extracted voucher; and
performing a settlement processing using one or a plurality of extracted vouchers on the commodity.

10. The method according to claim 9, further comprising
designating a voucher displayed; and
performing settlement processing using the voucher designated from a plurality of vouchers displayed.

11. The method according to claim 10, wherein the settlement processing includes a discount processing, an exchange processing, or a reduction processing on a commodity to which the voucher designated is available among the plurality of vouchers displayed.

12. The method according to claim 11, further comprising:
designating a commodity to which the voucher is applied;
displaying commodities to which the voucher designated is available; and
performing settlement processing using the voucher associated with the commodity specifying information of the commodity designated from among the plurality of commodities displayed.

13. The method according to claim 12, further comprising:
displaying a number of required vouchers in accordance with a number of commodities designated.

14. A POS terminal, comprising:
a display configured to display information;
a commodity specifying information acquisition determination section configured to determine whether commodity specifying information for specifying a commodity is acquired;
a declaration section configured to declare use of a voucher;
a voucher extraction section configured to extract a voucher available to the commodity specified by the commodity specifying information acquired by the commodity specifying information acquisition determination section from vouchers stored in a memory in association with the commodity specifying information, based on the commodity specifying information acquired by the commodity specifying information acquisition determination section when the use of the voucher is declared;
a display control section configured to control the display to display an extracted voucher; and
a settlement section configured to perform a settlement processing using one or a plurality of extracted vouchers on the commodity.

15. The POS terminal according to claim 14, further comprising a voucher designation section configured to designate a voucher displayed on the display, wherein the settlement section performs settlement processing using the voucher designated by the voucher designation section from the vouchers displayed on the display.

16. The POS terminal according to claim 15, wherein the settlement section performs settlement processing including a discount processing, an exchange processing, or a reduction processing on a commodity to which the voucher designated by the voucher designation section is available among vouchers displayed on the display.

17. The POS terminal according to claim 16, further comprising a commodity designation section configured to designate a commodity to which the voucher is applied on the display, wherein
the display control section controls the display to display commodities to which the voucher designated by the voucher designation section is available, and
the settlement section performs settlement processing using the voucher associated with the commodity specifying information of the commodity designated by the commodity designation section among commodities displayed on the display.

18. The POS terminal according to claim 17, wherein the display control section controls the display to display a number of required vouchers in accordance with a number of commodities designated by the commodity designation section.

19. The POS terminal according to claim 14, wherein the commodity specifying information acquisition determination section determines whether commodity specifying information for specifying the commodity is acquired by scanning a barcode associated with the commodity.

20. The POS terminal according to claim 14, wherein the commodity specifying information comprises at least one of a commodity code, a commodity name, and a unit price of the commodity.
